(19) United States
(12) Patent Application Publication
(10) Pub. No.: US 2024/0399271 A1
(43) Pub. Date: Dec. 5, 2024

(54) LIQUID-SEALED PUMP OPERATING METHOD, MEMBRANE DEGASIFIER, PURE WATER PRODUCTION SYSTEM, AND PURE WATER PRODUCTION METHOD

(71) Applicant: Nomura Micro Science Co., Ltd., Kanagawa (JP)

(72) Inventors: Katsumi YAMAMOTO, Atsugi-shi, Kanagawa (JP); Takatsugu KITO, Atsugi-shi, Kanagawa (JP); Shinsuke SATO, Atsugi-shi, Kanagawa (JP); Shuhei TORIMURA, Atsugi-shi, Kanagawa (JP)

(73) Assignee: Nomura Micro Science Co., Ltd., Kanagawa (JP)

(21) Appl. No.: 18/698,027

(22) PCT Filed: Jul. 20, 2022
(86) PCT No.: PCT/JP2022/028237

§ 371 Date: Apr. 3, 2024

(30) Foreign Application Priority Data
Oct. 5, 2021 (JP) 2021-164278

(51) Int. Cl. B01D 19/00; C02F 1/20; C02F 1/44

(52) U.S. Cl. CPC B01D 19/0031; C02F 1/20; C02F 1/44; C02F 2201/004

(57) ABSTRACT

A liquid-sealed vacuum pump operating method includes: discharging a liquid from a vacuum pipe connected to a liquid-sealed vacuum pump; supplying a sealing liquid under pressure to the liquid-sealed vacuum pump such that the liquid-sealed vacuum pump contains a predetermined amount of the sealing liquid, and driving the liquid-sealed vacuum pump until a pressure in the vacuum pipe is reduced to a predetermined pressure; and stopping supply of the pressurized sealing liquid to the liquid-sealed vacuum pump in a case in which the pressure in the vacuum pipe is reduced to the predetermined pressure, and circulating the sealing liquid in a circulation flow path from the liquid-sealed vacuum pump to maintain a state in which the predetermined amount of the sealing liquid is present in the liquid-sealed vacuum pump.

### TECHNICAL FIELD

The present disclosure relates to a liquid-sealed pump operating method, a membrane degasifier, a pure water production system, and a pure water production method.

### BACKGROUND ART

In a membrane degasifier constituting a part of a pure water production apparatus or the like, condensed water is generated on a gas phase side in the membrane degasifier. This condensed water may cause a malfunction of the membrane degasifier. Due to this condensed water, for example, operation of a vacuum pump may be poor, or the area of a membrane through which a gas passes during degassing may be reduced, leading to deterioration of performance.

In order to solve such a disadvantage, JP 2000-185203 A describes a membrane degasifier operating method in which an inert gas is supplied into a hollow fiber membrane to eliminate vacuum after a water passing degassing step is stopped, whereby the hollow fiber membrane maintains a normal state.

### SUMMARY OF INVENTION

### Technical Problem

A liquid-sealed vacuum pump that suctions a membrane degasifier or the like may have a configuration in which a sealing liquid is circulated by a circulation flow path.

Here, for example, in a case where a membrane degasifier is driven (started) again after the membrane degasifier is stopped, a liquid may remain in a vacuum pipe disposed from the membrane degasifier to the liquid-sealed vacuum pump, and the degree of vacuum may decrease and the degree of vacuum may decrease also inside the liquid-sealed vacuum pump. Alternatively, the inside of the vacuum pipe may return to a normal pressure after the membrane degasifier is stopped.

The liquid-sealed vacuum pump is operated while the inside thereof is in a predetermined vacuum state, and a certain degree of vacuum or more is required in order to discharge the sealing liquid. Therefore, when the degree of vacuum is low as described above, the sealing liquid cannot be circulated in a circulation flow path, and the liquid-sealed vacuum pump cannot be driven.

However, there is no technique for enabling the liquid-sealed vacuum pump to be driven even in a state where the degree of vacuum of the vacuum pipe is low. For example, JP 2000-185203 A described above does not take into consideration that the degree of vacuum of a vacuum pipe may decrease due to generation of condensed water on a gas phase side of the membrane degasifier, and there is a risk that the liquid-sealed vacuum pump cannot be driven.

In addition, in order for the liquid-sealed vacuum pump to be appropriately driven, the amount of a sealing liquid in the liquid-sealed vacuum pump needs to be appropriate. For example, when the inside of the liquid-sealed vacuum pump is filled with the sealing liquid or the sealing liquid is insufficient, the liquid-sealed vacuum pump cannot be driven and stops.

An object of the present disclosure is to obtain a liquid-sealed vacuum pump operating method, a membrane degasifier, a pure water production system, and a pure water production method, namely, the liquid-scaled vacuum pump operating method is capable of driving a liquid-sealed vacuum pump even in a state where the degree of vacuum of a vacuum pipe is low, the membrane degasifier is capable of reliably degassing a liquid to be treated by including such a liquid-sealed vacuum pump even in a state where the degree of vacuum of the vacuum pipe is low, the pure water production system includes the membrane degasifier, and the pure water production method uses the pure water production system.

### Solution to Problem

A liquid-scaled vacuum pump operating method of a first aspect includes: discharging a liquid from a vacuum pipe connected to a liquid-sealed vacuum pump; supplying a sealing liquid under pressure to the liquid-sealed vacuum pump such that the liquid-sealed vacuum pump contains a predetermined amount of the sealing liquid, and driving the liquid-scaled vacuum pump until a pressure in the vacuum pipe is reduced to a predetermined pressure; and stopping supply of the pressurized sealing liquid to the liquid-sealed vacuum pump in a case in which the pressure in the vacuum pipe is reduced to the predetermined pressure, and circulating the scaling liquid in a circulation flow path from the liquid-sealed vacuum pump to maintain a state in which the predetermined amount of the sealing liquid is present in the liquid-sealed vacuum pump.

In the liquid-sealed vacuum pump operating method of the first aspect, even when a liquid is present in the vacuum pipe, for example, at the time of starting the liquid-sealed vacuum pump, the liquid is discharged. Therefore, it is possible to avoid occurrence of a situation in which an inside of the vacuum pump is filled with the liquid in the vacuum pipe and the liquid-sealed vacuum pump cannot be driven.

In addition, the sealing liquid is supplied to the liquid-scaled vacuum pump under pressure such that the liquid-sealed vacuum pump contains a predetermined amount of the sealing liquid. As a result, the amount of the sealing liquid in the liquid-sealed vacuum pump can be set to an amount suitable for driving the liquid-sealed vacuum pump. In addition, since the liquid-scaled vacuum pump is driven in a state in which the sealing liquid is supplied under pressure until the pressure in the vacuum pipe is reduced to a predetermined pressure, operation can be continued without stopping the liquid-sealed vacuum pump, and the degree of vacuum of the vacuum pipe can reach a predetermined range.

When the pressure in the vacuum pipe is reduced to a predetermined pressure, supply of the sealing liquid to the liquid-sealed vacuum pump is stopped. In addition, the scaling liquid is circulated in the circulation flow path from the liquid-sealed vacuum pump, and a state in which a predetermined amount of the sealing liquid is present in the liquid-sealed vacuum pump is maintained. An operating state of the liquid-sealed vacuum pump can be maintained using the sealing liquid circulating in the circulation flow path.

As described above, in the liquid-sealed vacuum pump operating method of the first aspect, the liquid-scaled vacuum pump can be driven even in a case in which the degree of vacuum of the vacuum pipe is low.

In a second aspect, the liquid is discharged from the vacuum pipe by supplying a pressurized gas to the vacuum pipe.

Since the pressurized gas is supplied to the vacuum pipe, the liquid is easily discharged from the vacuum pipe.

In a third aspect, the liquid in the vacuum pipe is sent to the liquid-sealed vacuum pump by supplying a pressurized gas to the vacuum pipe.

A process for discharging the liquid in the vacuum pipe to a member other than the liquid-sealed vacuum pump is unnecessary, and the liquid is easily discharged from the vacuum pipe.

In a fourth aspect, the pressurized sealing liquid is supplied to the liquid-sealed vacuum pump from an intermediate position of the circulation flow path.

Since the circulation flow path is used as a part of a flow path for supplying the pressurized sealing liquid to the liquid-sealed vacuum pump, the scaling liquid is easily supplied.

In a fifth aspect, the pressurized scaling liquid is introduced from the intermediate position of the circulation flow path between a gas-liquid separation tank and the liquid-sealed vacuum pump at the circulation flow path.

Therefore, the pressurized sealing liquid can be supplied to the liquid-sealed vacuum pump without being sent to the gas-liquid separation tank.

In a sixth aspect, excessive sealing liquid of the liquid-sealed vacuum pump is discharged through the circulation flow path.

Since the excessive sealing liquid of the liquid-sealed vacuum pump can be circulated through the circulation flow path, the scaling liquid is not wasted as compared with a configuration in which a waste liquid of the liquid-sealed vacuum pump is directly discarded from the liquid-scaled vacuum pump.

A membrane degasifier of a seventh aspect includes: a liquid-sealed vacuum pump; a membrane degassing member an inside thereof being suctioned by a vacuum pipe that is connected to the liquid-sealed vacuum pump; a discharge unit discharging a liquid from the vacuum pipe; a circulation flow path connected to the liquid-scaled vacuum pump, a scaling liquid being circulated in the circulation flow path; and a supply member supplying the pressurized sealing liquid to the liquid-scaled vacuum pump.

Since the membrane degasifier includes the discharge unit, even when a liquid is present in the vacuum pipe, for example, at the time of starting the liquid-sealed vacuum pump, the degree of vacuum of the vacuum pipe can be high and the degree of vacuum of the liquid-sealed vacuum pump can also be high by discharging the liquid by the discharge unit.

In addition, the amount of the sealing liquid of the liquid-sealed vacuum pump can be adjusted to an amount suitable for driving by supplying the pressurized sealing liquid to the liquid-sealed vacuum pump by the supply member. The degree of vacuum of the vacuum pipe can be set within a predetermined range by driving the liquid-sealed vacuum pump until the pressure in the vacuum pipe reaches a predetermined pressure.

When the pressure in the vacuum pipe reaches a predetermined pressure, supply of the sealing liquid to the liquid-sealed vacuum pump by the supply member is stopped, and the scaling liquid is circulated in the circulation flow path. That is, an operating state of the liquid-sealed vacuum pump can be maintained using the sealing liquid circulating in the circulation flow path, and degassing can be performed by the membrane degassing member. Even in a state in which the degree of vacuum of the vacuum pipe is low due to stop of the membrane degasifier, it is possible to reliably drive the liquid-sealed vacuum pump and to perform degassing by the membrane degassing member.

A pure water production system of an eighth aspect includes: a pure water production apparatus producing pure water obtained by removing impurities from raw water; and the membrane degasifier of the seventh aspect, which constitutes a part of the pure water production apparatus and which removes a gas from treated water during production of the pure water or removes a gas from the produced pure water.

Since this pure water production system includes the membrane degasifier of the seventh aspect, even in a state in which the degree of vacuum of the vacuum pipe is low due to stop of the membrane degasifier, it is possible to reliably drive the liquid-scaled vacuum pump and to perform degassing by the membrane degassing member. In addition, a gas can be removed from treated water during production of the pure water or a gas can be removed from the produced pure water by the membrane degassing member.

A pure water production method of a ninth aspect is a pure water production method for producing pure water by a pure water production system, the pure water production system including: a pure water production apparatus producing pure water obtained by removing impurities from raw water; and a membrane degasifier constituting a part of the pure water production apparatus and removing a gas from treated water during production of the pure water or removing a gas from the produced pure water. The pure water production method includes: discharging a liquid from a vacuum pipe that connects the membrane degasifier to a liquid-sealed vacuum pump; supplying a sealing liquid under pressure to the liquid-sealed vacuum pump such that the liquid-scaled vacuum pump contains a predetermined amount of the sealing liquid, and driving the liquid-scaled vacuum pump until a pressure in the vacuum pipe is reduced to a predetermined pressure; and stopping supply of the pressurized sealing liquid to the liquid-sealed vacuum pump in a case in which the pressure in the vacuum pipe is reduced to the predetermined pressure, and circulating the sealing liquid in a circulation flow path from the liquid-scaled vacuum pump to maintain a state in which the predetermined amount of the scaling liquid is present in the liquid-scaled vacuum pump.

In the pure water production method, when pure water is produced by the pure water production system, a gas can be removed from treated water during production of the pure water or a gas can be removed from the produced pure water by the membrane degasifier. The inside of the membrane degasifier is suctioned through the vacuum pipe using the liquid-scaled vacuum pump.

Even in a case in which a liquid is present in the vacuum pipe, for example, at the time of starting the liquid-scaled vacuum pump, this liquid is discharged. Therefore, it is possible to avoid occurrence of a situation in which the inside of the vacuum pump is filled with the liquid in the vacuum pipe and the liquid-scaled vacuum pump cannot be driven.

In addition, the scaling liquid is supplied to the liquid-scaled vacuum pump under pressure such that the liquid-sealed vacuum pump contains a predetermined amount of the scaling liquid. The amount of the sealing liquid in the liquid-scaled vacuum pump can be set to an amount suitable for driving. In addition, since the liquid-sealed vacuum pump is driven in a state in which the sealing liquid is pressurized until the pressure in the vacuum pipe is reduced to a predetermined pressure, operation can be continued without stopping the liquid-sealed vacuum pump, and the degree of vacuum of the vacuum pipe can reach a predetermined range.

In a case in which the pressure in the vacuum pipe is reduced to a predetermined pressure, supply of the sealing liquid to the liquid-sealed vacuum pump is stopped. In addition, the sealing liquid is circulated in the circulation flow path, and a state in which a predetermined amount of the sealing liquid is present in the liquid-sealed vacuum pump is maintained. An operating state of the liquid-sealed vacuum pump can be maintained using the sealing liquid circulating in the circulation flow path.

As described above, in the pure water production method of the ninth aspect, the liquid-sealed vacuum pump can be driven even when the degree of vacuum of the vacuum pipe is low. In addition, the inside of the membrane degasifier can be suctioned by operation of the liquid-sealed vacuum pump.

### Advantageous Effects of Invention

In the present disclosure, the liquid-sealed vacuum pump can be driven even when the degree of vacuum of the vacuum pipe is low.

### BRIEF DESCRIPTION OF DRAWINGS

FIG. 1 is a configuration diagram of a pure water production system including a membrane degasifier of a first embodiment.

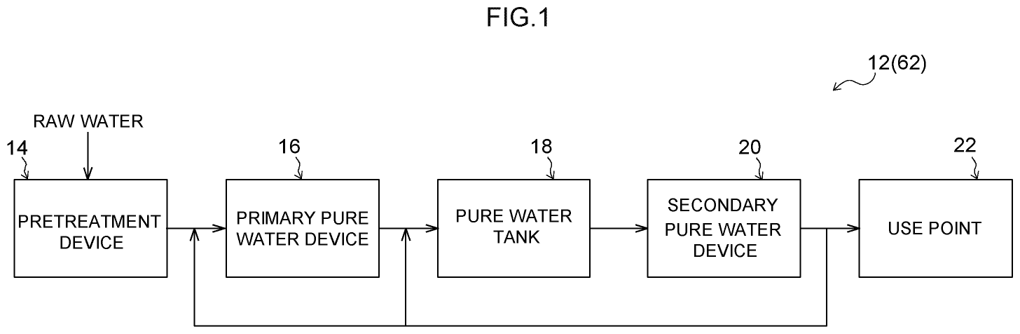

FIG. 2 is a configuration diagram illustrating the membrane degasifier of the first embodiment.

FIG. 3 is a configuration diagram illustrating a state during driving of the membrane degasifier of the first embodiment.

FIG. 4 is a configuration diagram illustrating a state during driving of the membrane degasifier of the first embodiment.

FIG. 5 is a configuration diagram illustrating a state during driving of the membrane degasifier of the first embodiment.

FIG. 6 is a configuration diagram illustrating a state during driving of the membrane degasifier of the first embodiment.

### DESCRIPTION OF EMBODIMENTS

Hereinafter, a membrane degasifier whose inside is suctioned by a liquid-sealed vacuum pump according to a first embodiment and a pure water production system including the membrane degasifier will be described with reference to the drawings.

A pure water production system 12 of the first embodiment includes a pure water production apparatus 62 that produces pure water obtained by removing impurities from raw water. The pure water production apparatus 62 includes a pretreatment device 14, a primary pure water device 16, a pure water tank 18, a secondary pure water device 20, and a use point 22. A membrane degasifier 24 described later constitutes a part of the pure water production apparatus 62.

Raw water is supplied to the pretreatment device 14. Examples of the raw water include industrial water, tap water, groundwater, and river water.

The pretreatment device 14 performs a treatment such as removal of turbidity to obtain pretreated water in which some of suspended substances and organic substances was removed from raw water. Note that the pretreatment device 14 may be omitted depending on water quality of the raw water.

The primary pure water device 16 adsorbs particles remaining in the pretreated water using an adsorbent such as activated carbon, and removes inorganic ions, organic substances, fine particles, and the like by using a membrane filtration device such as a reverse osmosis membrane device. The primary pure water device 16 may include an ion exchange device or an ultraviolet irradiation device. The ion exchange device removes remaining ions and the like from the pretreated water.

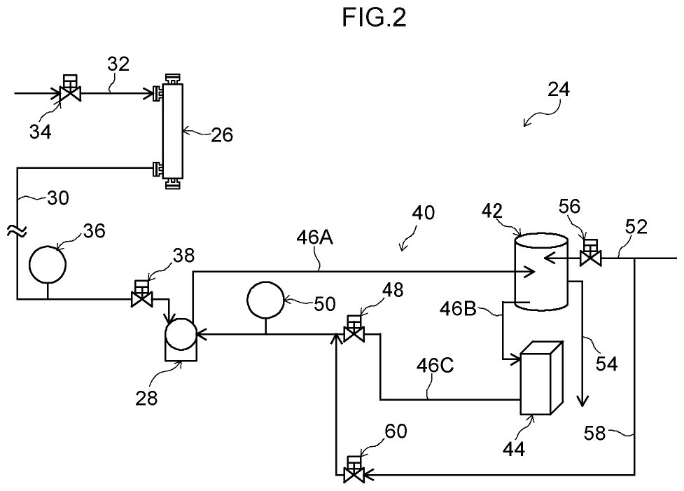

In the first embodiment, the primary pure water device 16 further removes a dissolved gas such as dissolved oxygen from the pretreated water using the membrane degasifier 24 (see FIG. 2).

The positions of the various devices described above in the primary pure water device 16, that is, an order thereof in a flow direction of the pretreated water is an order appropriate to each treatment, and is not limited to a specific order.

In the primary pure water device 16, as described above, the pretreated water obtained by the treatment in the pretreatment device 14 is further subjected to a cleaning treatment as necessary to remove impurities, thereby obtaining primary pure water.

The primary pure water obtained by the primary pure water device 16 is sent to the pure water tank 18. The pure water tank 18 is a container that temporarily stores the primary pure water obtained by the primary pure water device 16.

The primary pure water stored in the pure water tank 18 is sent to the secondary pure water device 20.

The secondary pure water device 20 includes, for example, an ultraviolet irradiation device. The ultraviolet irradiation device irradiates the primary pure water with ultraviolet rays to perform decomposition of organic substances in the primary pure water, a treatment of killing live bacteria (sterilization), and the like. The secondary pure water device 20 may further have a configuration in which impurity ions such as an organic acid generated in the ultraviolet irradiation device are removed by an ion exchange device. In addition, similarly to the primary pure water device 16, the secondary pure water device 20 may have a configuration in which a gas in the primary pure water, particularly dissolved oxygen is removed by the membrane degasifier.

The secondary pure water device 20 of the present embodiment further includes a membrane filtration device (UF). The membrane filtration device (UF) removes fine particles from the primary pure water to obtain ultrapure water.

The ultrapure water obtained by the secondary pure water device 20 is sent to the use point 22 which is a use place. Unused ultrapure water out of the sent ultrapure water is directly circulated to the primary pure water device 16 or the pure water tank 18.

FIG. 2 illustrates the membrane degasifier 24 used in the primary pure water device 16. The membrane degasifier 24 is disposed at a primary pure water flow path through which the primary pure water as a liquid to be treated flows, and includes a membrane degassing member 26. A hollow fiber membrane is disposed inside the membrane degassing member 26 as an example, and the inside of the membrane degassing member 26 is partitioned into a gas phase portion and a liquid phase portion by the hollow fiber membrane.

A liquid to be degassed, which is the primary pure water in the technique of the present disclosure, is supplied to the liquid phase portion of the membrane degassing member 26. The gas phase portion is decompressed by a liquid-scaled vacuum pump 28 described later, whereby a gas in the primary pure water passes through the hollow fiber membrane and moves to the gas phase portion. As a result, a dissolved gas is removed from the primary pure water.

The membrane degassing member 26 is connected to the liquid-scaled vacuum pump 28 by the vacuum pipe 30. Furthermore, in the present embodiment, a gas supply pipe 32 is connected to the gas phase portion of the membrane degassing member 26. The gas supply pipe 32 includes a gas supply valve 34. By driving a gas supply pump (not illustrated) and opening the gas supply valve 34, a predetermined gas (for example, a N₂ gas) can be supplied to the gas phase portion of the membrane degassing member 26.

The vacuum pipe 30 includes a gas pressure sensor 36 that detects an internal pressure, and a vacuum on-off valve 38 that opens and closes the vacuum pipe 30.

A circulation flow path 40 is connected to the liquid-sealed vacuum pump 28. The circulation flow path 40 includes a gas-liquid separation tank 42 and a heat exchanger 44. The circulation flow path 40 is configured such that a sealing liquid is circulated from the liquid-scaled vacuum pump 28, via the gas-liquid separation tank 42 and the heat exchanger 44, returning to the liquid-sealed vacuum pump 28 through a plurality of circulation pipes 46A, 46B, and 46C. By circulating the scaling liquid in this manner, the scaling liquid discharged from the liquid-sealed vacuum pump 28 can be returned to the liquid-sealed vacuum pump 28 and reused.

The sealing liquid discharged from the liquid-sealed vacuum pump 28 may contain a gas. The gas-liquid separation tank 42 performs gas-liquid separation for the scaling liquid. Then, the sealing liquid from which a gas is removed by the gas-liquid separation tank 42 flows through the circulation pipe 46B and reaches the heat exchanger 44.

The heat exchanger 44 exchanges heat between the sealing liquid sent from the gas-liquid separation tank 42 to the liquid-sealed vacuum pump 28 and a heat medium (not illustrated), and sets a liquid temperature of the sealing liquid within a predetermined range. The sealing liquid whose temperature is adjusted by the heat exchanger 44 flows through the circulation pipe 46C.

The circulation pipe 46C includes a circulation on-off valve 48 and a flow meter 50. By opening the circulation on-off valve 48, the sealing liquid can be circulated in the circulation flow path 40.

The flow meter 50 detects the circulation amount of the scaling liquid (the amount of the sealing liquid flowing per unit time) in the circulation flow path 40. Data of the detected circulation amount is sent to a control device (not illustrated). The control device performs control such that the liquid-sealed vacuum pump 28 is in a driving state in a case in which the circulation amount of the sealing liquid is within a predetermined range, and the liquid-sealed vacuum pump 28 is in a stopped state in a case in which the circulation amount of the sealing liquid is not within the predetermined range.

A sealing liquid supply pipe 52 and a scaling liquid discharge pipe 54 are connected to the gas-liquid separation tank 42. The sealing liquid supply pipe 52 includes a scaling liquid supply valve 56. The sealing liquid supply pipe 52 further includes a pressurizing pump (not illustrated). By driving the pressurizing pump and opening the sealing liquid supply valve 56, the sealing liquid can be supplied to the gas-liquid separation tank 42. The scaling liquid overflowing from the gas-liquid separation tank 42 is discharged from the sealing liquid discharge pipe 54.

A branch pipe 58 is branched from the sealing liquid supply pipe 52 on an upstream side (right side in FIG. 2) of the scaling liquid supply valve 56 in a flow direction of the sealing liquid. The branch pipe 58 joins the circulation pipe 46C between the circulation on-off valve 48 and the flow meter 50.

The branch pipe 58 includes a branch on-off valve 60. By closing the sealing liquid supply valve 56 and opening the branch on-off valve 60, the pressurized sealing liquid can be sent to the liquid-sealed vacuum pump 28 without passing through the gas-liquid separation tank 42.

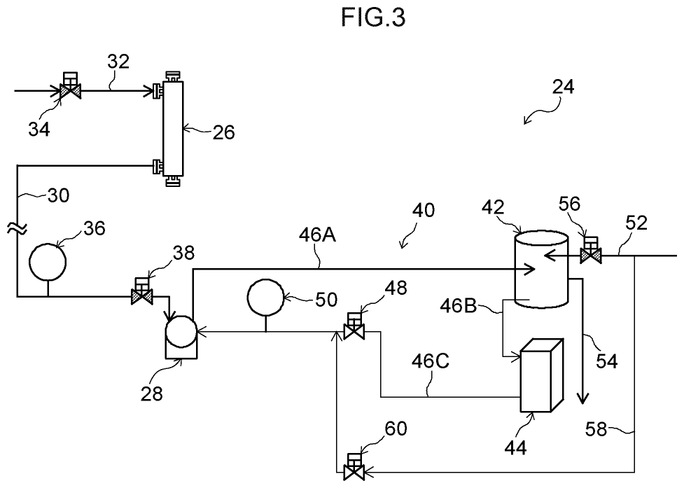

An effect of the present embodiment and the liquid-scaled vacuum pump operating method will be described. Note that, in each of the valves in FIGS. 3 to 6, a case where the valve is in a closed state is indicated by white, and a case where the valve is in an open state is indicated by black. In each of the pipes, a state in which a fluid is flowing is indicated by a thick line, and a state in which a fluid is not flowing is indicated by a thin line.

Here, a case in which operation is restarted from a state where the membrane degasifier 24 is stopped will be exemplified. In this case, in the vacuum pipe 30, for example, condensed water (an example of a liquid in the vacuum pipe 30) generated on the gas phase side of the membrane degasifier 24 may be present. The degree of vacuum of the vacuum pipe 30 may be low due to the condensed water, and the degree of vacuum inside the liquid-sealed vacuum pump 28 may also be low. Note that the state in which the degree of vacuum of the vacuum pipe 30 is low and the degree of vacuum inside the liquid-sealed vacuum pump 28 is also low as described above may occur, for example, in a case in which operation of a new membrane degasifier 24 is started, in a case in which some elements, for example, the liquid-scaled vacuum pump 28 is replaced in the existing membrane degasifier 24, or in a case in which the membrane degasifier 24 is urgently stopped for some reason.

However, the liquid-scaled vacuum pump 28 is a pump that is driven in a state where the degree of vacuum inside the liquid-scaled vacuum pump 28 is a predetermined degree of vacuum. When the degree of vacuum of the liquid-scaled vacuum pump 28 is low, the scaling liquid cannot be circulated in the circulation flow path 40. In this case, since the flow meter 50 detects that the circulation amount of the scaling liquid in the circulation flow path 40 is not within a predetermined range, a control device (not illustrated) stops driving of the liquid-sealed vacuum pump 28 even when the liquid-sealed vacuum pump 28 is driven.

Meanwhile, in the liquid-scaled vacuum pump operating method of the technique disclosed in the present application, first, as illustrated in FIG. 3, condensed water is discharged from the vacuum pipe 30 without driving the liquid-scaled vacuum pump 28. In the membrane degasifier 24 of the present embodiment, since the gas supply pipe 32 is connected to the membrane degassing member 26, both the gas supply valve 34 and the vacuum on-off valve 38 are opened, and a gas is caused to flow from the gas supply pipe 32 to the vacuum pipe 30 via the membrane degasifier 24. As a result, the liquid in the vacuum pipe 30 can be sent into the liquid-sealed vacuum pump 28 together with the supplied gas, and the condensed water can be discharged from the vacuum pipe 30. In this case, a pressure for supplying the gas is not required to be high as long as the condensed water in the vacuum pipe 30 can be discharged. For example, the supply pressure is preferably 0.01 to 0.4 MPa, and more preferably 0.04 to 1.5 MPa. As the gas, for example, an inert gas such as a nitrogen gas or an argon gas, or air can be used.

Here, the sealing liquid discharged from the liquid-sealed vacuum pump 28 flows to the gas-liquid separation tank 42 via the circulation pipe 46A. Furthermore, the sealing liquid overflowing from the gas-liquid separation tank 42 is discharged to the outside from the scaling 5 liquid discharge pipe 54.

Note that, at this stage, the circulation on-off valve 48 and the branch on-off valve 60 are closed such that the sealing liquid does not flow into the liquid-scaled vacuum pump 28 from the circulation flow path 40. In addition, it is preferable to supply the pressurized sealing liquid to the gas-liquid separation tank 42 by opening the scaling liquid supply valve 56.

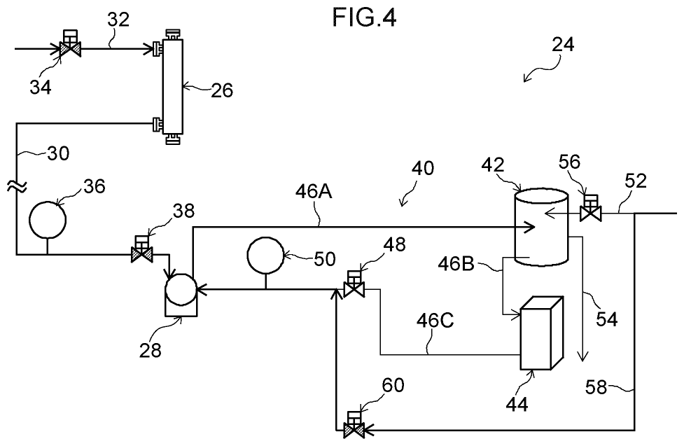

Next, as illustrated in FIG. 4, the sealing liquid supply valve 56 is closed, and the branch on-off valve 60 is opened. As a result, the pressurized scaling liquid is sent to the liquid-sealed vacuum pump 28 via the branch pipe 58 and a part of the circulation pipe 46C (a portion on a downstream side of a junction of the branch pipe 58). Also in this state, the scaling liquid discharged from the liquid-scaled vacuum pump 28 flows to the gas-liquid separation tank 42 via the circulation pipe 46A. Note that the circulation on-off valve 48 maintains a closed state, and the sealing liquid does not flow from the gas-liquid separation tank 42 to the liquid-sealed vacuum pump 28. The sealing liquid to be supplied under pressure is preferably water. Raw water such as city water or industrial water, pure water, ultrapure water, purified water, and the like, and intermediate treated water, which are made when pure water and the like are produced, can be used. Pure water, ultrapure water, purified water, or the like, or intermediate treated water, which is made when pure water and the like are produced, is still more preferably as a scaling liquid from a viewpoint of keeping the inside of the membrane degasifier 24, particularly the inside of the membrane degassing member 26 clean. A supply pressure of the scaling liquid is preferably 0.05 to 0.4 MPa, and more preferably 0.1 to 0.2 MPa.

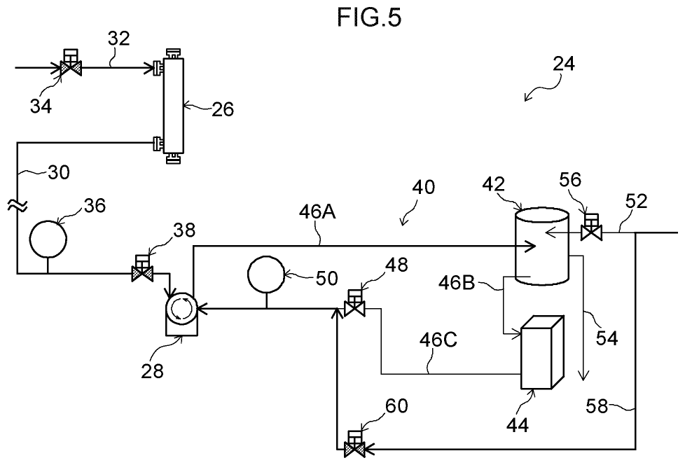

As illustrated in FIG. 5, the liquid-scaled vacuum pump 28 is driven by a control device (not illustrated), and a gas is suctioned from the vacuum pipe 30. This increases the degree of vacuum of the vacuum pipe 30. The degree of vacuum of the liquid-sealed vacuum pump 28 also increases. Since a pressure in the vacuum pipe 30 is detected by the gas pressure sensor 36, the liquid-scaled vacuum pump 28 is continuously driven until the degree of vacuum of the vacuum pipe 30 reaches a predetermined range (reduced to a predetermined pressure).

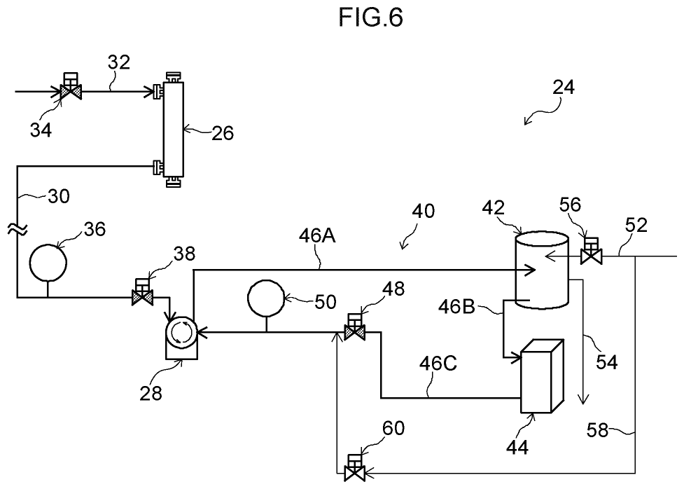

When the degree of vacuum of the vacuum pipe 30 reaches the predetermined range, as illustrated in FIG. 6, the branch on-off valve 60 is closed, and the circulation on-off valve 48 is opened. As a result, the sealing liquid is sent to the liquid-scaled vacuum pump 28 by the scaling liquid circulated in the circulation flow path 40. That is, a state in which a predetermined amount of the sealing liquid is present in the liquid-sealed vacuum pump 28 is maintained, and the liquid-sealed vacuum pump 28 is continuously operated.

As can be seen from the above description, in the present embodiment, even when a liquid is present in the vacuum pipe 30 and the degree of vacuum of the vacuum pipe 30 is low, the liquid-scaled vacuum pump 28 can be driven.

The membrane degasifier 24 including the liquid-sealed vacuum pump 28 is incorporated in the primary pure water device 16 in the present embodiment. That is, in a process of producing primary pure water by the primary pure water device 16, the membrane degasifier 24 can be reliably driven from a stopped state, and can degas water to be treated (pretreated water).

As described above, in the above description, an exemplary embodiment has been described in which the membrane degasifier 24 is incorporated in the primary pure water device 16, but the membrane degasifier 24 may be incorporated in the secondary pure water device 20 in place of or in combination with the primary pure water device 16. In short, the membrane degasifier 24 only needs to constitute a part of the pure water production apparatus 62 and to be incorporated in a part of the pure water production system 12.

The pure water production system according to the technique of the present disclosure is not limited to the configuration including the secondary pure water device 20, and may have a configuration in which pure water produced by the primary pure water device 16 is sent to the use point 22. In the configuration including the secondary pure water device 20, pure water obtained by the secondary pure water device 20 is water obtained by further removing impurities as compared with the primary pure water obtained by the primary pure water device 16, and may be referred to as ultrapure water. That is, the pure water production system according to the technique of the present disclosure also includes an ultrapure water production system capable of substantially producing ultrapure water.

In the pure water production system according to the technique of the present disclosure, the pretreatment device 14 may be omitted depending on the type of raw water. That is, even a configuration not including the pretreatment device 14 is included in the pure water production system of the technique disclosed in the present application.

In the above exemplary embodiment, as an example of the discharge unit that discharges a liquid from the vacuum pipe 30, a configuration has been described in which the liquid is sent to the liquid-scaled vacuum pump 28 by a pressure of a gas supplied from the gas supply pipe 32, but the configuration of the discharge unit that discharges a liquid from the vacuum pipe 30 is not limited thereto. For example, a configuration may be adopted in which the liquid in the vacuum pipe 30 is discharged to the liquid-scaled vacuum pump 28 by gravity by locating the liquid-scaled vacuum pump 28 at a lowermost portion of the vacuum pipe 30 in the vertical direction. By adopting a configuration in which a pressurized gas is supplied to the vacuum pipe 30 as in the above-described embodiment, it is possible to more reliably discharge the liquid in the vacuum pipe 30 in a short time.

A discharge destination of the liquid in the vacuum pipe 30 is not limited to the liquid-scaled vacuum pump 28. For example, a configuration may be adopted in which a discharge pipe whose distal end is opened is branched from a lowermost portion of the vacuum pipe 30 in the vertical direction, and an on-off valve that opens and closes the discharge pipe is disposed. In this configuration, when the liquid is discharged from the vacuum pipe 30, it is only required to open the on-off valve. In the first exemplary embodiment of the present disclosure, since the liquid in the vacuum pipe 30 moves to the liquid-sealed vacuum pump 28, the branch pipe from the vacuum pipe 30 and the on-off valve described above are unnecessary. An opening and closing operation of the on-off valve is also unnecessary, and the liquid can be casily discharged from the vacuum pipe 30.

In the above exemplary embodiment, as an example of the supply member that supplies a pressurized sealing liquid to the liquid-sealed vacuum pump 28, a configuration has been described in which the branch pipe 58 is branched from the scaling liquid supply pipe 52 and joins the circulation flow path 40 (circulation pipe 46C). The branch pipe 58 may be disposed independently of the scaling liquid supply pipe 52 and the circulation flow path 40. In the configuration in which a pipe branched from the scaling liquid supply pipe 52 and joining the circulation flow path 40, such as the branch pipe 58 is disposed, the sealing liquid supply pipe 52 and the circulation flow path 40 also serve as a part of a flow path for sending the pressurized scaling liquid to the liquid-sealed vacuum pump 28, and therefore the structure can be simplified.

The branch pipe 58 joins the circulation flow path 40 on a downstream side of the gas-liquid separation tank 42. Therefore, the pressurized sealing liquid can be supplied to the liquid-scaled vacuum pump 28 without being sent to the gas-liquid separation tank 42.

In the above description, the sealing liquid discharged in the process of supplying the pressurized sealing liquid to the liquid-sealed vacuum pump 28 is discharged to the gas-liquid separation tank 42 through the circulation flow path 40. The sealing liquid discharged from the liquid-scaled vacuum pump 28 flows through the circulation flow path 40 and returns to the liquid-scaled vacuum pump 28 again, and the scaling liquid is not wasted.

The whole of the disclosure of Japanese Patent Application No. 2021-164278 filed on Oct. 5, 2021 is incorporated herein by reference.

All the documents, patent applications, and technical standards described here are incorporated herein by reference to almost the same extent as a case where incorporation of each literature, patent application, and technical standard by reference is specifically and individually described.

1. A liquid-sealed vacuum pump operating method comprising:
discharging a liquid from a vacuum pipe connected to a liquid-sealed vacuum pump;
supplying a sealing liquid under pressure to the liquid-sealed vacuum pump such that the liquid-sealed vacuum pump contains a predetermined amount of the sealing liquid, and driving the liquid-sealed vacuum pump until a pressure in the vacuum pipe is reduced to a predetermined pressure; and
stopping supply of the pressurized sealing liquid to the liquid-sealed vacuum pump in a case in which the pressure in the vacuum pipe is reduced to the predetermined pressure, and circulating the sealing liquid in a circulation flow path from the liquid-sealed vacuum pump to maintain a state in which the predetermined amount of the sealing liquid is present in the liquid-sealed vacuum pump.

2. The liquid-sealed vacuum pump operating method according to claim 1, wherein the liquid is discharged from the vacuum pipe by supplying a pressurized gas to the vacuum pipe.

3. The liquid-sealed vacuum pump operating method according to claim 2, wherein the liquid in the vacuum pipe is sent to the liquid-sealed vacuum pump by supplying a pressurized gas to the vacuum pipe.

4. The liquid-sealed vacuum pump operating method according to claim 1, wherein the pressurized sealing liquid is supplied to the liquid-sealed vacuum pump from an intermediate position of the circulation flow path.

5. The liquid-sealed vacuum pump operating method according to claim 4, wherein the pressurized sealing liquid is supplied to the intermediate position of the circulation flow path, the intermediate position being located between a gas-liquid separation tank and the liquid-sealed vacuum pump at the circulation flow path.

6. The liquid-sealed vacuum pump operating method according to claim 1, wherein excessive sealing liquid of the liquid-sealed vacuum pump is discharged through the circulation flow path.

7. A membrane degasifier comprising:
a liquid-sealed vacuum pump;
a membrane degassing member, an inside thereof being suctioned by a vacuum pipe that is connected to the liquid-sealed vacuum pump;
a discharge unit discharging a liquid from the vacuum pipe;
a circulation flow path connected to the liquid-sealed vacuum pump, a sealing liquid being circulated in the circulation flow path; and
a supply member supplying pressurized sealing liquid to the liquid-sealed vacuum pump.

8. A pure water production system comprising:
a pure water production apparatus producing pure water obtained by removing impurities from raw water; and
the membrane degasifier according to claim 7, which constitutes a part of the pure water production apparatus and which removes a gas from treated water during production of the pure water or removes a gas from the produced pure water.

9. A pure water production method for producing pure water by a pure water production system, the pure water production system including:
a pure water production apparatus that produces pure water obtained by removing impurities from raw water; and
a membrane degasifier constituting a part of the pure water production apparatus and removing a gas from treated water during production of the pure water or removing a gas from the produced pure water,
the pure water production method comprising:
discharging a liquid from a vacuum pipe connecting the membrane degasifier to a liquid-sealed vacuum pump;
supplying a sealing liquid under pressure to the liquid-sealed vacuum pump such that the liquid-sealed vacuum pump contains a predetermined amount of the sealing liquid, and driving the liquid-sealed vacuum pump until a pressure in the vacuum pipe is reduced to a predetermined pressure; and
stopping supply of the pressurized sealing liquid to the liquid-sealed vacuum pump in a case in which the pressure in the vacuum pipe is reduced to the predetermined pressure, and circulating the sealing liquid in a circulation flow path from the liquid-sealed vacuum pump to maintain a state in which the predetermined amount of the sealing liquid is present in the liquid-sealed vacuum pump.
